(19) United States
(12) Patent Application Publication
(10) Pub. No.: US 2024/0426173 A1
(43) Pub. Date: Dec. 26, 2024

(54) COLLAPSIBLE STEP LADDER DEVICE

(71) Applicant: Frederick Marini, Melrose, WI (US)

(72) Inventor: Frederick Marini, Melrose, WI (US)

(21) Appl. No.: 18/213,063

(22) Filed: Jun. 22, 2023

(51) Int. Cl. E06C 1/20; E06C 7/18

(52) U.S. Cl. CPC E06C 1/20; E06C 7/182; E06C 7/183

(57) ABSTRACT

A collapsible step ladder device includes a step ladder that has a pair of front legs each hingedly coupled to a pair of back legs to facilitate the step ladder to be positioned between a deployed position or a stored position. The step ladder including a plurality of steps each pivotally attached to the pair of front legs. Each of the plurality of steps is horizontally oriented when the step ladder is in the deployed position to be stepped upon by a user climbing the step ladder. The step ladder includes a pair of handrails which can be gripped by the user when the user is climbing the step ladder to assist climbing the step ladder. A support is attached between the pair of front legs to facilitate the user to lean against the support when the user has climbed the step ladder.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to step ladder devices and more particularly pertains to a new step ladder device for facilitating a physically limited user to climb a step ladder. The device includes a step ladder that has steps which are spaced more closely together than a traditional step ladder to assist a physically limited user with climbing the steps. The device includes a pair of handrails that the user can grip and a support that the user can lean against when the user has climbed the step ladder.

### (2) Description of Related Art Including Information Disclosed Under 37 CFR 1.97 and 1.98

The prior art relates to step ladder devices including a variety of step ladders that include a single handrail and a step ladder that includes a pair of handrails and a hip support and which is not collapsible. In no instance does the prior art disclose a collapsible step ladder that includes a pair of handrails and a hip support.

### BRIEF SUMMARY OF THE INVENTION

An embodiment of the disclosure meets the needs presented above by generally comprising a step ladder that has a pair of front legs each hingedly coupled to a pair of back legs to facilitate the step ladder to be positioned between a deployed position or a stored position. The step ladder including a plurality of steps each pivotally attached to the pair of front legs. Each of the plurality of steps is horizontally oriented when the step ladder is in the deployed position to be stepped upon by a user climbing the step ladder. The step ladder includes a pair of handrails which can be gripped by the user when the user is climbing the step ladder to assist climbing the step ladder. A support is attached between the pair of front legs to facilitate the user to lean against the support when the user has climbed the step ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a collapsible step ladder device according to an embodiment of the disclosure.

FIG. 2 is a left side view of an embodiment of the disclosure.

FIG. 3 is a front view of an embodiment of the disclosure.

FIG. 4 is a left view of an embodiment of the disclosure showing a step ladder in a stored position.

FIG. 5 is a top view of an embodiment of the disclosure.

FIG. 6 is a perspective in-use view of an embodiment of the disclosure.

### DETAILED DESCRIPTION OF THE INVENTION

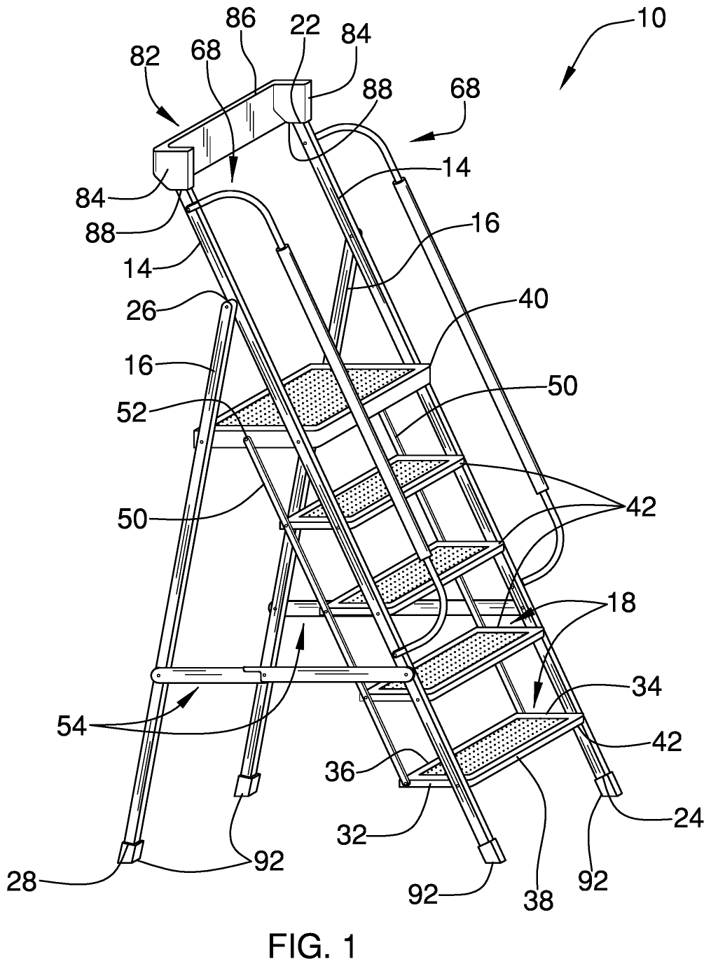

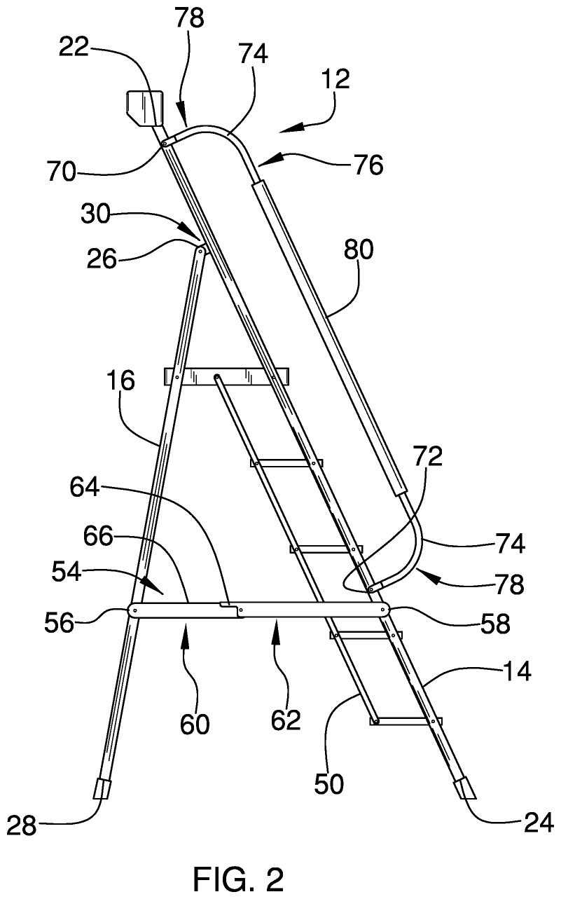

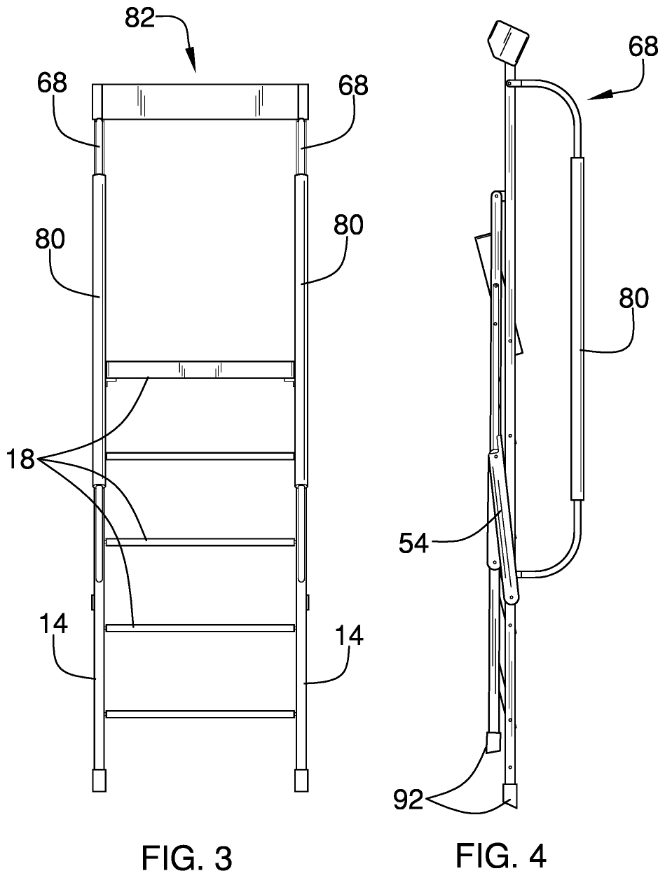

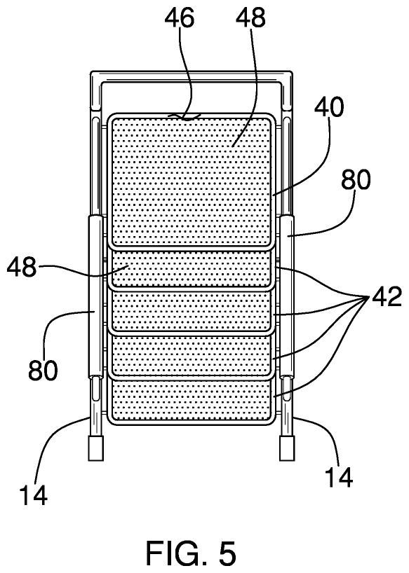

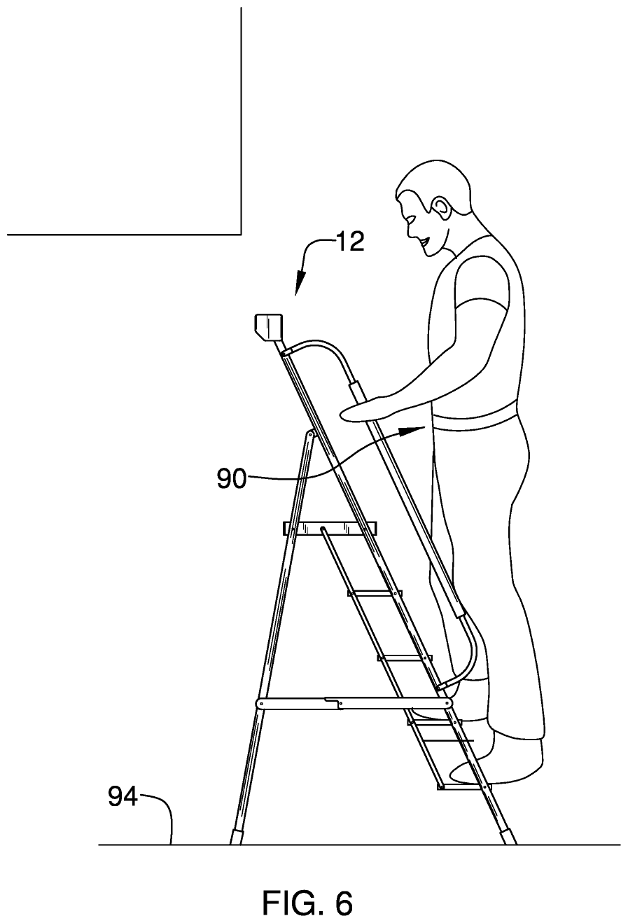

With reference now to the drawings, and in particular to FIGS. 1 through 6 thereof, a new step ladder device embodying the principles and concepts of an embodiment of the disclosure and generally designated by the reference numeral 10 will be described.

As best illustrated in FIGS. 1 through 6, the collapsible step ladder device 10 generally comprises a step ladder 12 that has a pair of front legs 14 which is each hingedly coupled to a pair of back legs 16. In this way the step ladder 12 can be positioned between a deployed position having the front legs 14 angling away from the back legs 16 or a stored position having the front legs 14 resting against the back legs 16. The step ladder 12 includes a plurality of steps 18 pivotally attached to the pair of front legs 14. Each of the plurality of steps 18 is horizontally oriented when the step ladder 12 is in the deployed position such that each of the plurality of steps 18 can be stepped upon by a user 20 climbing the step ladder 12. Conversely, each of the plurality of steps 18 lies flat against each other when the step ladder 12 is in the stored position. The plurality of steps 18 may be spaced apart from each other a distance of less than 25.0 cm when the step ladder 12 is in the deployed position thereby facilitating a physically limited user 20, such as an elder person for example, to ascend the steps 18.

Each of the front legs 14 has an upper end 22 and a lower end 24 and each of the back legs 16 has a top end 26 and a bottom end 28. The top end 26 of each of the back legs 16 is pivotally coupled to a respective one of the front legs 14 at a pivot point 30 that is located closer to the upper end 22 of the respective front leg 14 than the lower end 24 of the respective front leg 14. Each of the plurality of steps 18 has a first lateral side 32, a second lateral side 34, a back side 36 and a front side 38. Additionally, each of the first lateral side 32 and the second lateral side 34 of each of the plurality of steps 18 is pivotally attached to a respective one of the front legs 14 at a point located adjacent to the front side 38 of the steps 18.

The plurality of steps 18 includes a topmost step 40 and a set of lower steps 42. Each of the first lateral side 32 and the second lateral side 34 of the topmost step 40 is pivotally coupled to a respective one of the back legs 16 at a point located adjacent to the back side 36 of the topmost step 40. The topmost step 40 has a depth that is greater than the depth of each of the set of lower steps 42. Furthermore, the topmost step 40 has a depth that is sufficient to accommodate the entire length of the user's feet 44 to facilitate the user 20 to safely stand on the topmost step 40. Each of the set of lower steps 42 has a depth that is less than the depth of the topmost step 40. Each of the plurality of steps 18 has a top surface 46 and each of the plurality of steps 18 includes a pad 48 that is applied to the top surface 46 and which is comprised of a friction enhancing material, and which may be textured, to inhibit the user 20 from slipping on the steps 18 when the user 20 is climbing the step ladder 12.

The step ladder 12 includes a pair of support members 50 and each of the support members 50 is pivotally coupled to a respective one of the first lateral side 32 and the second lateral side 34 of each of the plurality of lower steps 42 at a point located adjacent to the back side 36 of the lower steps 42. An upper end 52 of each of the pair of support members 50 is pivotally coupled to a respective one of the first lateral side 32 and the second lateral side 34 of the topmost step 40 at a point located adjacent to the back side 36 of the topmost step 40. Each of the pair of support members 50 facilitates the topmost step 40 to support the weight of each of the plurality of lower steps 42 when the step ladder 12 is positioned in the deployed position.

The step ladder 12 includes a pair of braces 54 and each of the braces 54 has a first end 56 and a second end 58 and each of the braces 54 includes a first portion 60 that is hingedly coupled to a second portion 62. The first end 56 of each of the pair of braces 54 is pivotally attached to a respective one of the back legs 16 and the second end 58 of each of the pair of braces 54 is pivotally attached to a respective one of the front legs 14. The second portion 62 of each of the braces 54 has a finger 64 which extends over a top edge 66 of the first portion 60 when the step ladder 12 is positioned in the deployed position to inhibit the braces 54 from folding downwardly thereby retaining the step ladder 12 in the deployed position. In this way the braces 54 restrict the distance that the front legs 14 can angle away from the back legs 16. Furthermore, each of the pair of braces 54 folds upwardly when the step ladder 12 is positioned in the stored position.

The step ladder 12 includes a pair of handrails 68 and each of the handrails 68 is attached to the step ladder 12. Each of the handrails 68 can be gripped by the user 20 when the user 20 is climbing the step ladder 12 to assist climbing the step ladder 12. Each of the handrails 68 has a primary end 70 and a secondary end 72 and each of the handrails 68 has a pair of bends 74 to define a central portion 76 of the handrails 68 extending between a pair of end portions 78 each being perpendicularly oriented with the central portion 76. Each of the primary end 70 and the secondary end 72 is associated with a respective one of the end portions 78. Furthermore, each of the primary end 70 and the secondary end 72 of each of the handrails 68 is attached to a respective one of the pair of front legs 14 having the central portion 76 of each of the pair of handrails 68 being oriented parallel to the respective front leg 14. In this way the central portion 76 of each of the pair of handrails 68 can be gripped by the user 20 when the user 20 is climbing the step ladder 12. A pair of cushions 80 is each positioned around the central portion 76 of a respective one of the handrails 68 having each of the cushions 80 extending along a substantial length of the central portion 76 of the respective handrail 68. Each of the cushions 80 is comprised of a resiliently compressible material, including but not being limited to rubber or silicone, to enhance comfort for the user 20.

A support 82 is attached to and extends between the pair of front legs 14 and the support 82 is positioned above the plurality of steps 18. The support 82 facilitates the user 20 to lean against the support 82 when the user 20 has climbed the step ladder 12 to inhibit the user 20 from falling off of the step ladder 12. The support 82 has a pair of wings 84 that is each perpendicularly oriented with a central panel 86 and each of the wings 84 has a lower edge 88 that is coupled to the upper end 22 of each of the front legs 14 of the step ladder 12. In this way the central panel 86 extends between the pair of front legs 14 to facilitate the user 20 to lean against the central panel 86 when the user 20 is standing on the topmost step 40. Additionally, the upper end 22 of each of the front legs 14 may be spaced from the topmost step 40 a distance of at least 90.0 cm thereby facilitating the central panel 86 to rest against the user's waist 90 when the user 20 is standing on the topmost step 40 to fully support the user 20. A plurality of feet 92 is provided and each of the feet 92 is coupled to a respective one of the bottom end 28 of a respective one of said back legs 16 and a respective one of the lower end 24 of a respective one of the front legs 14. Each of the plurality of feet 92 is comprised of a resiliently compressible material, including but not being limited to rubber or silicone, thereby facilitating the feet 92 to inhibit slipping on a support surface 94 when the user 20 is employing the step ladder 12.

In use, the step ladder 12 is positioned in the deployed position to facilitate the user 20 to climb the step ladder 12. The user 20 grips each of the handrails 68 and the user 20 steps on each of the plurality of steps 18 to climb to a desired height on the step ladder 12. Furthermore, the spacing of the steps 18 facilitates the user 20 to climb the step ladder 12 with an increased degree of ease as compared to existing step ladders which may have spacing between the steps that is too much for the user 20 to safely climb. In this way an elderly person could safely climb the step ladder 12 to replace a light bulb, for example, or to perform any other task that would otherwise require the user 20 to attempt to climb a ladder that they either cannot safely climb or that they cannot climb at all. The step ladder 12 is positioned in the stored position to facilitate the step ladder 12 to be placed in storage.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collapsible step ladder device which has handrail and closely spaced steps to facilitate a physically limited person to ascend, said device comprising:
a step ladder having a pair of front legs each being hingedly coupled to a pair of back legs to facilitate said step ladder to be positioned between a deployed position having said front legs angling away from said back legs or a stored position having said front legs resting against said back legs, said step ladder including a plurality of steps each being pivotally attached to said pair of front legs, each of said plurality of steps being horizontally oriented when said step ladder is in said deployed position wherein each of said plurality of steps is configured to be stepped upon by a user climbing said step ladder, each of said plurality of steps lying flat against each other when said step ladder is in said stored position;
wherein said step ladder includes a pair of handrails, each of said handrails being attached to said step ladder wherein each of said handrails is configured to be gripped by the user when the user is climbing said step ladder to assist climbing said step ladder; and
a support being attached to and extending between said pair of front legs, said support being positioned above said plurality of steps wherein said support is configured to facilitate the user to lean against said support when the user has climbed said step ladder to inhibit the user from falling off of said step ladder.

2. The device according to claim 1, wherein:
each of said front legs has an upper end and a lower end;
each of said back legs has a top end and a bottom end;
said top end of each of said back legs is pivotally coupled to a respective one of said front legs at a pivot point being located closer to said upper end of said respective front leg than said lower end of said respective front leg;
each of said plurality of steps has a first lateral side, a second lateral side, a back side and a front side;
each of said first lateral side and said second lateral side of each of said plurality of steps is pivotally attached to a respective one of said front legs at a point located adjacent to said front side of said steps;
said plurality of steps includes a topmost step and a set of lower steps; and
each of said first lateral side and said second lateral side of said topmost step is pivotally coupled to a respective one of said back legs at a point located adjacent to said back side of said topmost step.

3. The device according to claim 2, wherein:
said step ladder includes a pair of support members, each of said support members being pivotally coupled to a respective one of said first lateral side and said second lateral side of each of said plurality of lower steps at a point located adjacent to said back side of said lower steps;
an upper end of each of said pair of support members is pivotally coupled to a respective one of said first lateral side and said second lateral side of said topmost step at a point located adjacent to said back side of said topmost step; and
each of said pair of support members facilitates said topmost step to support the weight of each of said plurality of lower steps when said step ladder is positioned in said deployed position.

4. The device according to claim 1, wherein:
said step ladder includes a pair of braces, each of said braces having a first end and a second end;
each of said braces includes a first portion being hingedly coupled to a second portion;
said first end of each of said pair of braces is pivotally attached to a respective one of said back legs;
said second end of each of said pair of braces is pivotally attached to a respective one of said front legs;
said second portion of each of said braces has a finger which extends over a top edge of said first portion when said step ladder is positioned in said deployed position to inhibit said braces from folding downwardly thereby retaining said step ladder in said deployed position; and
each of said pair of braces folds upwardly when said step ladder is positioned in said stored position.

5. The device according to claim 1, wherein each of said handrails has a primary end and a secondary end, each of said handrails having a pair of bends to define a central portion of said handrails extending between a pair of end portions each being perpendicularly oriented with said central portion, each of said primary end and said secondary end being associated with a respective one of said end portions, each of said primary end and said secondary end of each of said handrails being attached to a respective one of said pair of front legs having said central portion of each of said pair of handrails being oriented parallel to said respective front leg wherein said central portion of each of said pair of handrails is configured to be gripped by the user when the user is climbing said step ladder.

6. The device according to claim 5, further comprising a pair of cushions, each of said cushions being positioned around said central portion of a respective one of said handrails having each of said cushions extending along a substantial length of said central portion of said respective handrail, each of said cushions being comprised of a resiliently compressible material wherein each of said pair of cushions is configured to enhance comfort for the user.

7. The device according to claim 1, wherein said support has a pair of wings each being perpendicularly oriented with a central panel, each of said wings having a lower edge being coupled to an upper end of each of said front legs of said step ladder such that said central panel extends between said pair of front legs wherein said central panel is configured to have the user lean against said central panel.

8. A collapsible step ladder device which has handrail and closely spaced steps to facilitate a physically limited person to ascend, said device comprising:
a step ladder having a pair of front legs each being hingedly coupled to a pair of back legs to facilitate said step ladder to be positioned between a deployed position having said front legs angling away from said back legs or a stored position having said front legs resting against said back legs, said step ladder including a plurality of steps each being pivotally attached to said pair of front legs, each of said plurality of steps being horizontally oriented when said step ladder is in said deployed position wherein each of said plurality of steps is configured to be stepped upon by a user climbing said step ladder, each of said plurality of steps lying flat against each other when said step ladder is in said stored position, each of said front legs having an upper end and a lower end, each of said back legs having a top end and a bottom end, said top end of each of said back legs being pivotally coupled to a respective one of said front legs at a pivot point being located closer to said upper end of said respective front leg than said lower end of said respective front leg, each of said plurality of steps having a first lateral side, a second lateral side, a back side and a front side, each of said first lateral side and said second lateral side of each of said plurality of steps being pivotally attached to a respective one of said front legs at a point located adjacent to said front side of said steps, said plurality of steps including a topmost step and a set of lower steps, each of said first lateral side and said second lateral side of said topmost step being pivotally coupled to a respective one of said back legs at a point located adjacent to said back side of said topmost step;
wherein said step ladder includes a pair of support members, each of said support members being pivotally coupled to a respective one of said first lateral side and said second lateral side of each of said plurality of lower steps at a point located adjacent to said back side of said lower steps, an upper end of each of said pair of support members being pivotally coupled to a respective one of said first lateral side and said second lateral side of said topmost step at a point located adjacent to said back side of said topmost step, each of said pair of support members facilitating said topmost step to support the weight of each of said plurality of lower steps when said step ladder is positioned in said deployed position;
wherein said step ladder includes a pair of braces, each of said braces having a first end and a second end, each of said braces including a first portion being hingedly coupled to a second portion, said first end of each of said pair of braces being pivotally attached to a respective one of said back legs, said second end of each of said pair of braces being pivotally attached to a respective one of said front legs, said second portion of each of said braces having a finger which extends over a top edge of said first portion when said step ladder is positioned in said deployed position to inhibit said braces from folding downwardly thereby retaining said step ladder in said deployed position, each of said pair of braces folding upwardly when said step ladder is positioned in said stored position;
wherein said step ladder includes a pair of handrails, each of said handrails being attached to said step ladder wherein each of said handrails is configured to be gripped by the user when the user is climbing said step ladder to assist climbing said step ladder, each of said handrails having a primary end and a secondary end, each of said handrails having a pair of bends to define a central portion of said handrails extending between a pair of end portions each being perpendicularly oriented with said central portion, each of said primary end and said secondary end being associated with a respective one of said end portions, each of said primary end and said secondary end of each of said handrails being attached to a respective one of said pair of front legs having said central portion of each of said pair of handrails being oriented parallel to said respective front leg wherein said central portion of each of said pair of handrails is configured to be gripped by the user when the user is climbing said step ladder;
a pair of cushions, each of said cushions being positioned around said central portion of a respective one of said handrails having each of said cushions extending along a substantial length of said central portion of said respective handrail, each of said cushions being comprised of a resiliently compressible material wherein each of said pair of cushions is configured to enhance comfort for the user; and
a support being attached to and extending between said pair of front legs, said support being positioned above said plurality of steps wherein said support is configured to facilitate the user to lean against said support when the user has climbed said step ladder to inhibit the user from falling off of said step ladder, said support having a pair of wings each being perpendicularly oriented with a central panel, each of said wings having a lower edge being coupled to said upper end of each of said front legs of said step ladder such that said central panel extends between said pair of front legs wherein said central panel is configured to have the user lean against said central panel.
